(19) United States
(12) Patent Application Publication
(10) Pub. No.: US 2024/0370819 A1
(43) Pub. Date: Nov. 7, 2024

(54) System and Method for Processing and Managing Retailer Transactions and Events

(71) Applicant: Hyde's Business Solutions Ltd., Niagara Falls (CA)

(72) Inventors: Gary Hyde, Niagara Falls (CA); Scott Galambos, Niagara Falss (CA)

(73) Assignee: Hyde's Business Solutions Ltd., Niagara Falls (CA)

(21) Appl. No.: 18/141,702

(22) Filed: May 1, 2023

(51) Int. Cl. G06Q 10/087; G06Q 30/0601

(52) U.S. Cl. CPC G06Q 10/087; G06Q 30/0603; G06Q 30/0641

(57) ABSTRACT

Disclosed is an electronic platform, system, and method for processing orders for a retailer and vendor. The system comprises a processor executing instructions that manage vendor data, retailer data, and order data; and provide a video call between the retailer and a vendor. The processor further executing instructions that: manage the vendor data and the order data in the database through commands provided through a first graphical user interface (GUI); and manage the video call in a second GUI. The system interfaces with a first electronic device associated with the retailer and a second electronic device associated with the selected vendor, where and the first and second processes generate the first and second GUIs on the first device.

### FIELD OF THE DISCLOSURE

The present disclosure relates to systems and methods for centrally processing and integrating business-related transactions and communications for retailers and vendors through a networked platform.

### DESCRIPTION OF THE BACKGROUND

In a common business-to-business (“B2B”) relationship, a vendor and a retailer are in a relationship, where the vendor offers its various products and services to the retailer, which then markets, advertises, and sells the vendors' products to the retailer's existing and potential customers. Typically, a retailer (e.g. Walmart Inc.) will typically have relationships with several vendors (e.g. The Coca Cola Company and PepsiCo, Inc. (soft drinks), Mars, Inc. (candy bars), Frito-Lay North America, Inc. (potato chips and snacks), Levi Strauss & Co. (clothing), and others), offering a selection of the vendors products for sale in a traditional physical retail stores (e.g. Walmart) and also in an online marketplace (e.g. Walmart.com). Also, a particular vendor (e.g., The Coca Cola Company) will typically have relationships with several retailers (e.g. Walmart Inc., Costco Wholesale Corp., 7-Eleven, Inc., and others) offering its products and services to sometimes direct competitors.

For a retailer, there are multiple processes and activities that must be tracked and targeted for its multiple processes (such as product orders, inventory tracking, advertisement tracking, and others).

Existing online and traditional processes provide a disparate set of different processes to individually handle each task.

There is a need to address deficiencies in the prior art.

### SUMMARY OF THE DISCLOSURE

In a first aspect, an electronic platform for processing orders related data for a retailer supporting a plurality of vendors is provided. The platform comprises: a processor executing instructions that: manage a database containing vendor data, retailer data, and order data; and provide a video call between the retailer and a selected vendor of the plurality of vendors. The processor further executes instructions that: in a first process, manage the vendor data and the order data in the database through commands provided through a first graphical user interface (GUI); in a second process, manage the video call in a second GUI; and in the first process, update the vendor data and the order data in the database through information provided through the video call in the second GUI. In the platform, a first electronic device is associated with the retailer is in communication with the platform to provide retailer data and order data to the database; a second electronic device is associated with the selected vendor is in communication with the platform to provide vendor data to the database; and the first and second processes generate the first and second GUIs on the first device.

In the platform the database may contain multiple vendors' data; and each vendor may be provided a separate operating platform from the other vendors.

In the platform, the first process may execute in parallel with the second process; and the first and second GUIs may be in view simultaneously on the first device.

In the platform, the database may further comprise flyer data, catalog data, and/or trigger events.

In the platform, the processor may further execute instructions that: review contents of database for a match between a trigger event and a matching vendor of the plurality of vendors in the vendor data; provide an electronic communication to a third device associated with the matching vendor upon the match; update the database upon the match; and store orders and then forwards orders to the third device.

In the platform, the processor may further execute instructions that: in the first process, manage the flyer data in the first GUI; and in the third process update the flyer data in the database. The flyer data may be captured in an interactive pdf document.

In the platform, the processor may further execute instructions that: in the second process, manage the catalog data in the second GUI; and in the third process update the catalog data in the database.

In the platform, the processor may further execute instructions that: in the first process through the first GUI, enable tagging of products with a tag identifier; and in the first process enable searching products having the same tag identifier.

In the platform, the processor may further execute instructions that in the first process: through the first GUI, enable searching of products having the tag identifier; and update the order data relating to the products having the same tag identifier.

In another aspect, a method for processing orders related data for a retailer supporting a plurality of vendors on an electronic platform is provided. The method comprises: executing instructions on a processor in the platform that: manage a database containing vendor data, retailer data, and order data; and provide a video call between the retailer and a selected vendor of the plurality of vendors. The method further comprises executing instructions on the processor that: in a first process, manage the vendor data and the order data in the database through commands provided through a first graphical user interface (GUI); in a second process, manage the video call in a second GUI; and in the first process, update the vendor data and the order data in the database through information provided through the video call in the second GUI. For the method, a first device is associated with the retailer is in communication with the platform to provide retailer data and order data to the database; a second device is associated with the selected vendor is in communication with the platform to provide vendor data to the database; and the first and second processes generate the first and second GUIs on the first device.

In the method, the database may contain multiple vendors' data; and each vendor may be provided a separate operating platform from the other vendors.

In the method, the first process may execute in parallel with the second process; and the first and second GUIs may be in view simultaneously on the first device.

In the method, the database may further comprise flyer data, catalog data, and/or trigger events.

The method may further execute instructions on the processor that: review contents of database for a match between a trigger event and a matching vendor of the plurality of vendors in the vendor data; provide an electronic communication to a third device associated with the matching vendor upon the match; update the database upon the match; and store orders and then forwards orders to the third device.

The method may further execute instructions on the processor that: in the first process, manage the flyer data in the first GUI; and in the third process update the flyer data in the database.

The method may further execute instructions on the processor that: in the second process, manage the catalog data in the second GUI; and in the third process update the catalog data in the database.

The method may further execute instructions on the processor that: in the first process through the first GUI, enable tagging of products with a tag identifier; and in the first process enable searching products having the same tag identifier.

A server and/or a device may be provided to implement any aspects of the method described.

In other aspects various combinations of sets and subsets of the above aspects are provided.

### BRIEF DESCRIPTION OF THE DRAWINGS

Embodiments of the disclosure will now be described, by way of example only, with reference to the accompanying drawings, in which:

FIG. 1 is a schematic block diagram of an operations processing platform located in a communication network which is in communication with remote client devices having applications installed thereon providing access to the platform according to an embodiment;

FIG. 2 is a schematic block diagram of the processing platform of FIG. 1 and a database of the platform for an embodiment;

FIG. 3 is a block diagram flow chart of an order processing algorithm implemented by the platform for an embodiment of FIG. 1;

FIG. 4 is a block diagram flow chart of an order review algorithm implemented by the platform for an embodiment of FIG. 1;

FIG. 5a is a block diagram flow chart of an advertisement/flyer management algorithm implemented by the platform for an embodiment of FIG. 1;

FIG. 5b is a block diagram flow chart of a catalog management algorithm implemented by the platform for an embodiment of FIG. 1;

FIG. 6 is a block diagram flow chart of a communications management algorithm implemented by the platform for an embodiment of FIG. 1;

FIG. 7 is a block diagram flow chart of an action trigger algorithm implemented by the platform for an embodiment of FIG. 1;

FIG. 8 is a schematic block diagram of a graphical user interface (GUI) generated at a vendor client device accessing the processing platform of FIG. 1;

FIG. 9 is a schematic block diagram of a graphical user interface (GUI) generated at a retailer client device accessing the processing platform of FIG. 1;

FIGS. 10a-10d are schematic block diagrams of graphical user interfaces (GUIs) generated for various functions by the processing platform of FIG. 1; and

FIG. 11 is schematic block diagram of a graphical user interface (GUI) generated for a sales report function by the processing platform of FIG. 1.

### DETAILED DESCRIPTION OF EMBODIMENTS

Exemplary details of embodiments are provided herein. The description which follows and embodiments described therein are provided by way of illustration of an example or examples of particular embodiments of principles of the present disclosure. These examples are provided for the purposes of explanation and not limitation of those principles and of the disclosure. In the description which follows, like parts are marked throughout the specification and the drawings with the same respective reference numerals.

An embodiment is depicted in an electronic data-processing platform accessed by a retailer, where the platform provides a centralized integrated electronic facility to store and process electronic data relating to vendors, product orders, inventory levels, advertisements, flyers, vendor catalogs, and other items for the retailer. The embodiment may also process communications and data with vendors (e.g. video calls, electronic reminders, etc.); provide electronic training videos and information; initiate periodic or event-based inquiries relating to triggers set by data in accounting, inventory, or other information; and integrate and cross-apply information, data, and notices among these functions. A retailer's orders to a vendor may be updated and

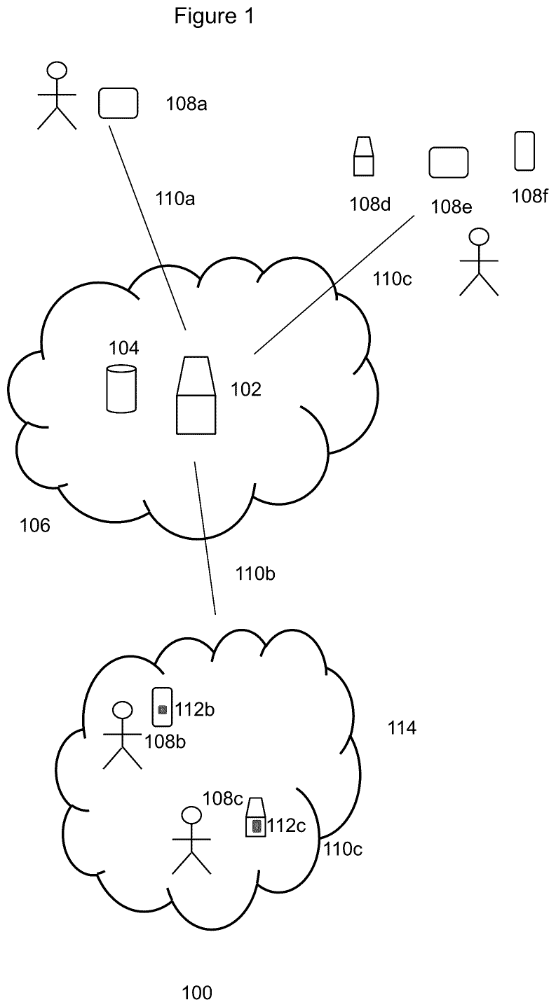

Turning now to FIG. 1, more features of an embodiment are described and shown in environment 100, providing a typical electronic communications network. Therein an instance of an embodiment is shown as operations processing platform 102, which for this instance is a retailer's platform. The related electronic data is stored, processed, and retrieved in database 104. As noted, platform 102 has facilities to communicate and process data remotely vendors and the retailer's representatives. For an embodiment, platform 102 and database 104 communicate with vendors and representatives via communication network 106 with electronic devices 108 through communication links 110. Each device 108 that communicates with platform 102 would have local client 112 (as software, e.g. an “app”) installed thereon. Client 112 provides an application program interface (API) to communicate with platform 102 through network 106. There are different types of clients for an embodiment: retailers; vendors; and system administrators. Further there may be multiple different vendors and retailers. Devices 108 include wireless mobile devices 108a,f, computing tablets 108b,e and computers/laptops 108c,d. Such devices 108 may implement various commercially-available platforms (e.g. Apple devices, Android devices, Microsoft devices, etc.). A group of devices (e.g. devices 112b,c) may be associated with the same vendor (or retailer) and managed through vendor network 114, which is connected to platform 102 through link 110b. Communication links 110 may be wireless or wired. Messages processed by platform 102 are electronic messages, such as emails, text messages, voice calls, etc. Various formats and transmission protocols may be used for communicating the messages, such as forms akin to email messages, text messages, voice mail messages, social network messages, custom datatypes, and other datatypes as known in the art.

As platform 102 may be accessed by vendors and representatives of the retailer, different access portals and related graphical user interfaces (GUIs) are provided for clients 112, depending on whether they are operated by a vendor or by a representative of the retailer.

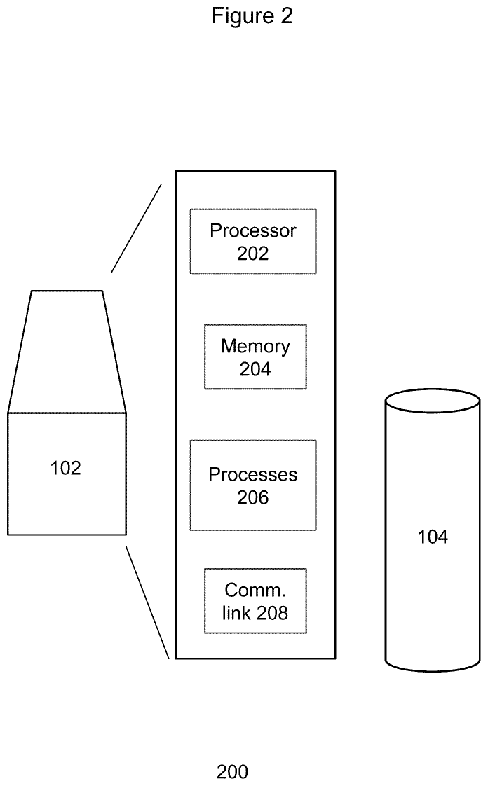

FIG. 2 shows components of platform 102, which may be implemented as server having commercially-available processor(s) with related components. The server may be implemented as one or more server(s) or other computationally-capable computing device(s). Platform 102 may be accessed directly at its terminal or remotely through network 106. Platform 102 has processor(s) 202, memory 204, access to database 104, and communication link module 208.

For platform 102, one or more processes 206 provide instructions to processor 202 to execute commands and data transactions implementing features of an embodiment performed by platform 102. One or more functions of platform 102 may be distributed among several devices. It will be appreciated that devices 108 and clients 112 may have similar corresponding components and structures to comparable components shown for platform 102. Database 104 stores vendors' records accessed by platform 102 and may be contained within system 106 or may be accessed remotely. Database 104 stores records and data relating associations for accounts, such as records relating to electronic messages (emails), text messages, recorded video, recorded audio, web pages, text, product data, advertisement samples, scheduled events and actions, and other data, events and actions. For database 104, a data record may be referred to as a record, data record, event, document, advertisement, item, search result, data element, etc. Other processes that provide operational and/or functional features for an embodiment may be provided through remote facilities (e.g. external, web-based processes providing external access to one or more facilities of an embodiment).

Now, further details are provided on exemplary processes 206 for an exemplary embodiment where platform 102 manages one retailer's orders with multiple vendors. The retailer may have several locations and sites. As such, the retailer has more direct control over operation of platform 102.

First, platform management process 206a is provided which implements overall management and coordination of business-related functions for the retailer. These functions include (but are not limited to): accessing database 104; accepting data; processing data for storage into database 104; accepting external data, requests, and commands from clients 112 (FIG. 1) and other sources; creating and generating database queries and extracting results to database 104; establishing and managing electronic communications such as video conferences; updating and generating reports; updating and generating advertisements; integrating data and related commands among processes, data, and clients; and implementing other processes for an embodiment.

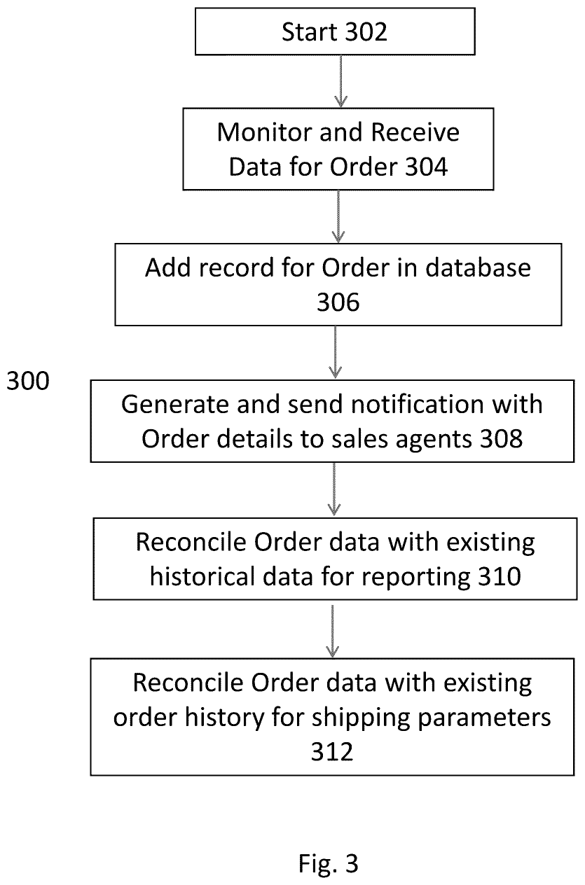

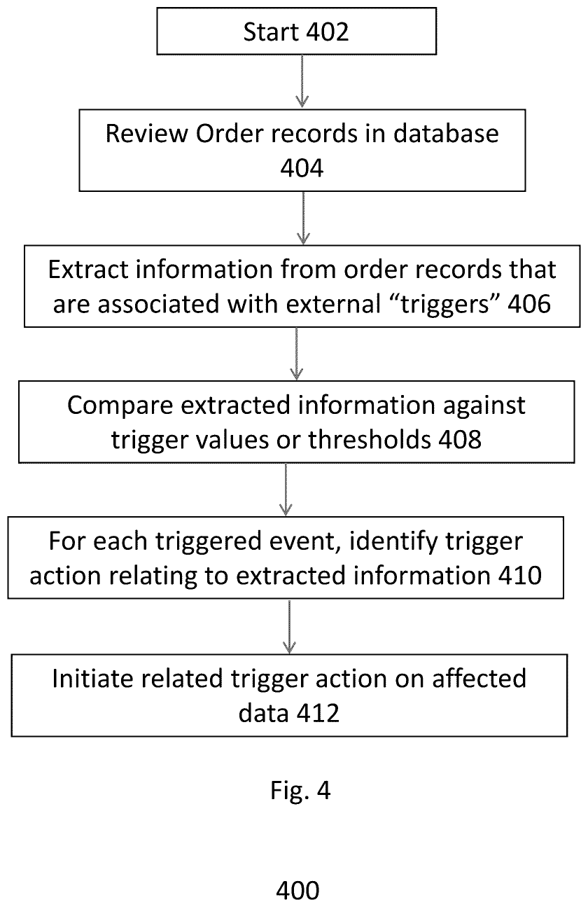

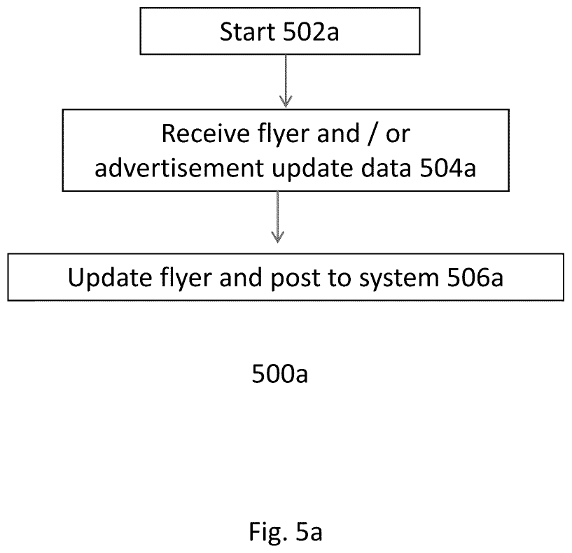

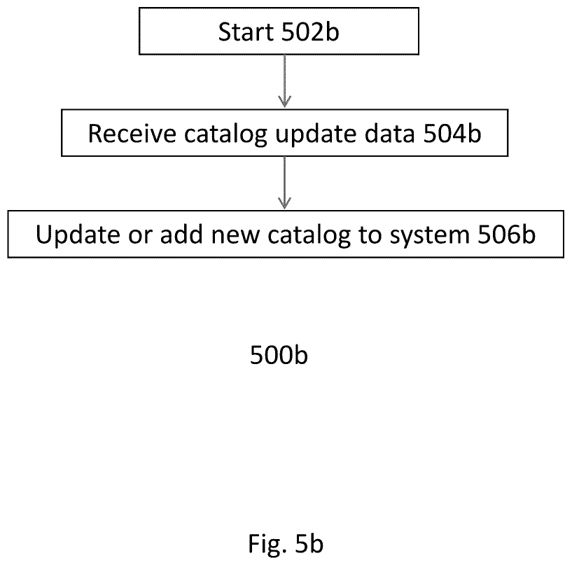

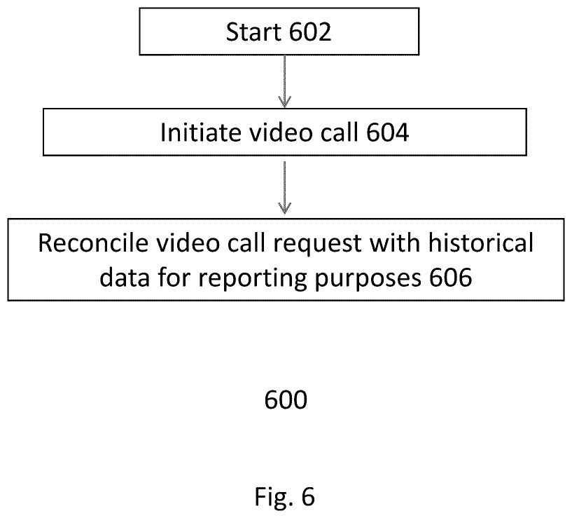

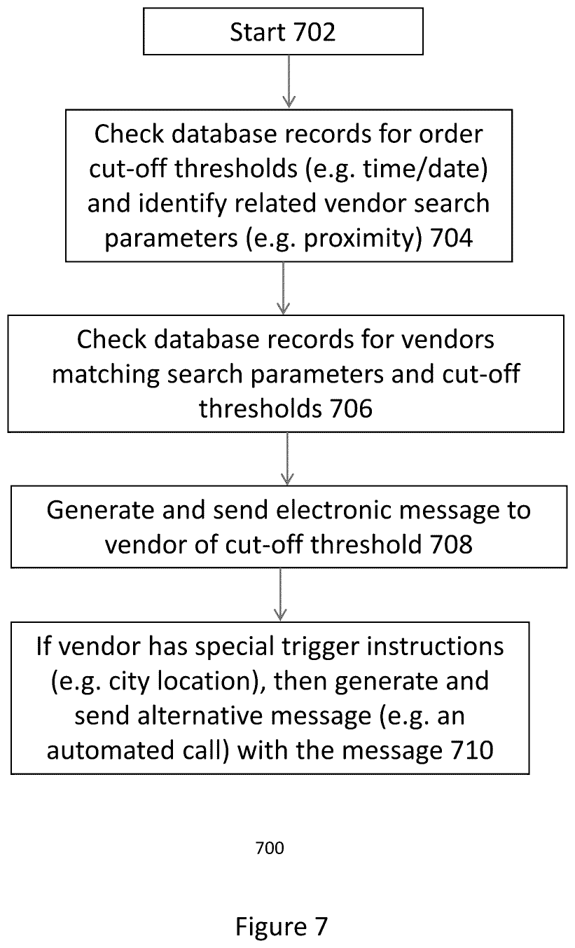

For an embodiment, process 206a comprises several sub-processes implementing functions described above, including: order processing sub-process 206b (see FIG. 3); order review sub-process 206c (see FIG. 4); advertisement management sub-process 206d (see FIG. 5a); catalog management sub-process 206e (see FIG. 5b); and video call management sub-process 206f (see FIG. 6); communication trigger management sub-process 206h (see FIG. 7); administrative sub-processes; and others. Each process may be executed in a separate processing thread, allowing concurrent/simultaneous operation of two or more processes as the underlying computational facilities in platform 102 permit.

Further details of algorithms of selected sub-process are now provided.

Referring to FIG. 3, algorithm 300 illustrates a general set of processes/actions executed collectively by order processing sub-process 206b in processing orders at platform 102 in response to data relating to an order received from client 112. Start process 302 is the initiation of sub-process 206b, which may include procedures to instantiate variables, set parameters, set communication links, and configure other ancillary items. From start 302, once its initiations are completed, algorithm 300 moves to process 304, which monitors for an event (which may be receipt of an order message from client 112 at device 108 or from a terminal connected to platform 102. Once an order event is received, algorithm 300 moves to process 306, which extracts the order data from the message (which may include the SKU, a description of the product, quantity, delivery times, prices, special notes, and instructions, etc.) and adds the order data in one or more records to database 104. Next, at process 308, the order data is analyzed to identify any notification(s) that are triggered by a trigger condition in the order and/or with the vendor. Once such notification(s) are identified, suitable electronic message(s) or other notices are generated and sent to the related parties. For example, if the state of the order triggers a notification to a particular sales representative for the retailer, then one or more messages (e.g. an email message, a text notification, etc.) can be created and sent to that representative providing details of the order. After all notifications are sent, next a series of order reconciliations may be conducted, where at process 310, the order data is analyzed to reconcile the order with any historic data relating to the order/SKU/vendor etc. identify any notifications that are triggered by the trigger condition in the order and/or with the vendor. For example, data for order details may be merged with data for historical orders and repots. After order reconciliations are completed, next, at process 312, the order data may be analyzed to reconcile the order with other parameters, e.g. shipping parameters. While not shown, it will be appreciated that other reconciliations/actions/notifications may be provided in algorithm 300.

Referring to FIG. 4, algorithm 400 illustrates a general set of processes/actions executed collectively by order processing sub-process 206c in applying order data at platform 102 in response to data relating to an order received from client 112. Start process 402 is the initiation of sub-process 206b, which may include procedures to instantiate variables, set parameters, set communication links, and configure other ancillary items. From start 402, once its initiations are completed, algorithm 400 moves to process 404, where a specific order is reviewed (which may be initiated from receipt of an order message from client 112 at device 108 or from a terminal connected to platform 102. Next, at process 406, which extracts any trigger data related to the order (which may include the Stock Keeping Unit number (SKU), inventory levels (e.g. low or high), pricing levels, delivery times, prices, special notes, instructions, etc.). Next, at process 408, the trigger data is analyzed against thresholds to identify any notification(s) that are triggered by the order and/or the vendor. Once such notification(s) are identified at process 410, suitable electronic actions (e.g. automatic renewal of order, message(s), or other notices are generated and sent to the related parties). For example, if the order triggers a notification to a particular sales representative for the retailer, then an email message is be created and sent to that representative providing details of the order. After actions are identified, next at process 412, such actions are initiated and data is updated, such as further processing of the order to related accounting systems. While not shown, it will be appreciated that other reconciliations/actions/notifications may be provided in algorithm 400.

Referring to FIGS. 5a and 5b, algorithms 500a and 500b illustrate general sets of processes/actions executed collectively by flyer, advertisement, and catalog processing sub-process 206d, e in updating flyers and catalogs stored at platform 102. A flyer is a retailer's publication (paper, online, email) that contains the retailer's current prices and offers. Certain flyers have specific event promotions (e.g. Halloween sales for a week in October). The content and form of the flyer is typically controlled by the retailer. However, a retailer may work with a vendor so that a vendor's certain product is highlighted in a flyer. This may require specific inventory/pricing agreements between the vendor and retailer for that product for a promotion (e.g. special products and prices for Valentine's Day). Typically, for a printed flyer, its contents cannot be changed once set. Nevertheless, in an embodiment, facilities may be provided for updating a printed flyer and/or information that is to be incorporated (e.g. for the next print run of the flyer).

In FIG. 5a, sub-process 206d has start process 502a, then it receives advertisement/flyer update information from a retailer or vendor at process 504a, and then at process 506a the related data items are identified and the updated information is applied to the relevant data in the flyer(s)/advertisement(s).

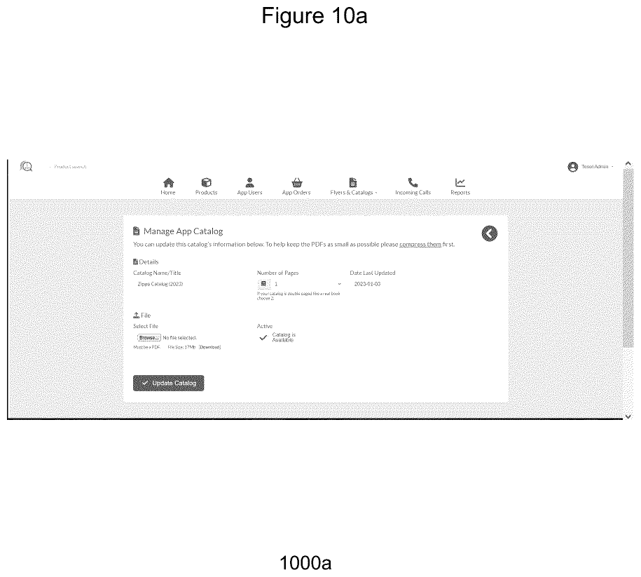

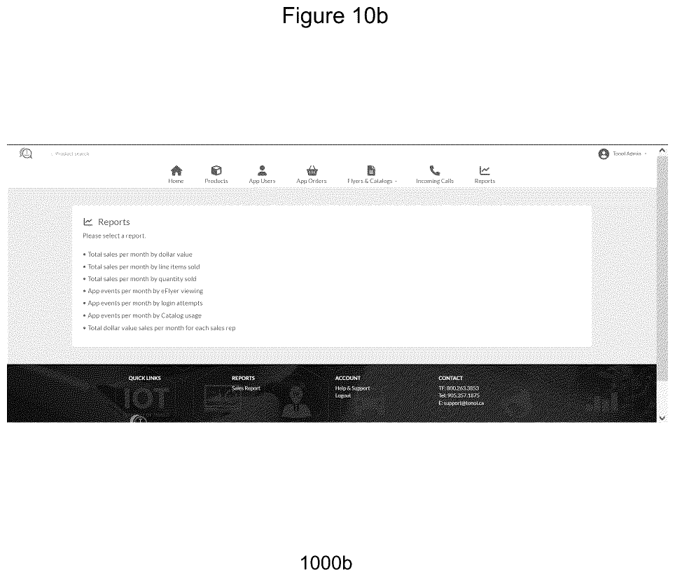

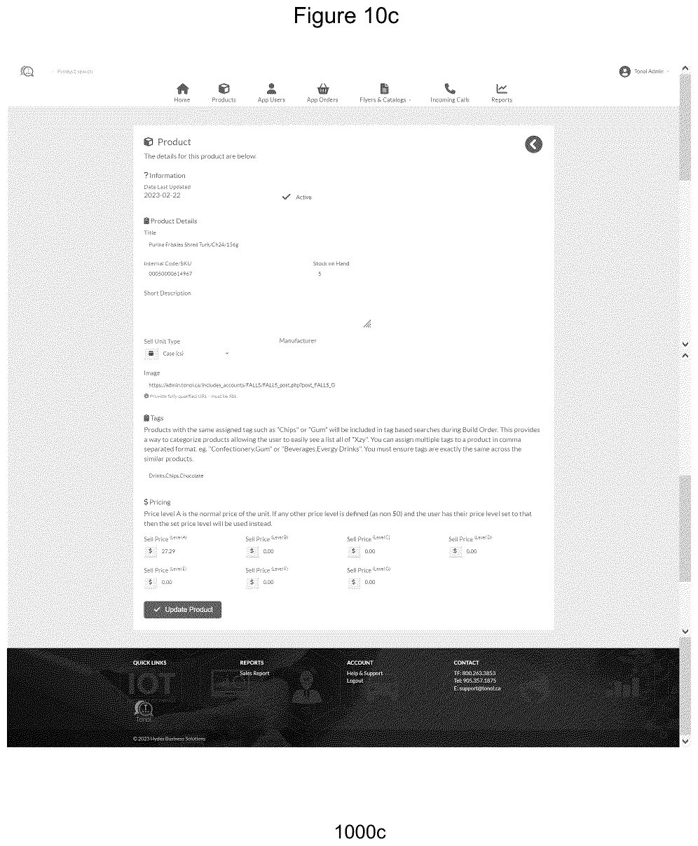

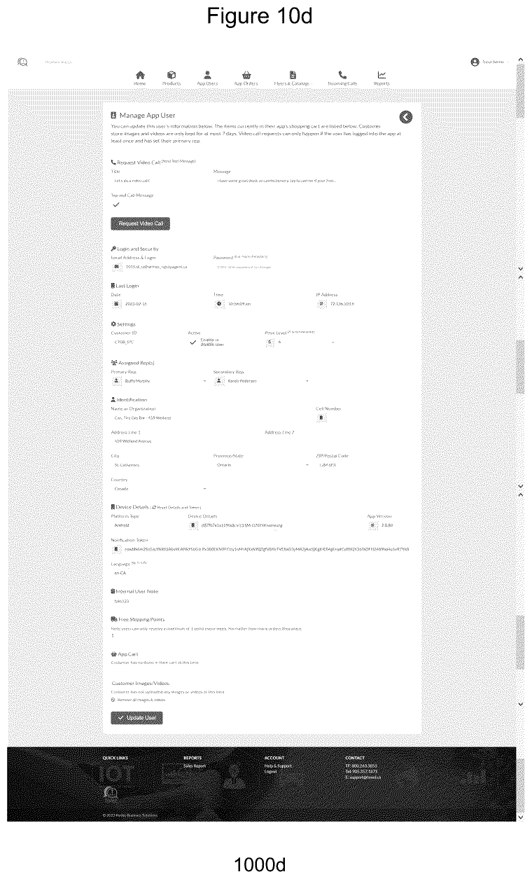

Referring to FIGS. 5b and 10a, algorithm 500b illustrates general sets of processes/actions executed by catalog processing sub-process 206e in updating catalogs stored at platform 102. Algorithm 500b is similar in features to algorithm 500a. Contrary to flyers, a catalog is a vendor's publication (paper, online, email) that contains the vendor's current products, descriptions, and prices. Typically a printed catalog is issued on a yearly or quarterly basis. The content and form of the catalog are typically controlled by the vendor. Typically, the contents of a catalog cannot be changed once set, but events may cause updates (e.g. supply issues on products and unexpected price adjustments). Sub-process 206e has start process 502b, then it receives catalog update information from a retailer or vendor at process 504b, and then at process 506b the related data items are identified and the updated information is applied to the relevant data in the catalog(s). Additional data and items (e.g. product videos, product manuals, FAQ information, reviews, etc.) may be stored and accessed in this feature. FIG. 10a shows exemplary screen image 1000a of a set of commands available under process 504b, showing in part action menus for updating and viewing catalog files.

Another embodiment manages and control contents of an electronic flyer (“e-flyer”) or an electronic catalog (“e-catalog”), via modified sub-processes 206d, e. In e-flyers and e-catalogs (collectively “e-documents”), products with their related information, images, and videos may be presented in dynamic, interactive, updateable electronic platforms (e.g. through websites). Typically, e-documents contain embedded fields, hyperlinks, and other data/command-activation areas permitting interactions with contents by viewers of the e-documents. An e-document may be implemented as an interactive pdf. For the e-documents, the order and arrangement of products can be updated, new products can be added, old products can be deleted, etc. Information and related data, text, images, and videos can be dynamically provided to platform 102 and updated for incorporation into the e-documents. As well, triggers can be set for changing contents of the e-documents (e.g. when an inventory level of a product drops below a threshold, various updates to the e-catalog may be implemented, such as: updating the product's description (e.g. with a lower inventory description); moving the placement of the product in the e-document (e.g. to a less prominent or more prominent location); deleting the product from the e-document; adding new products to the e-document; etc. Data, information, updates, and inquiries about a product may be provided to platform 102 through various inputs (e.g. updates from the vendor, retailer, and customer orders) either through data entered in relevant forms or inputs on a particular webpage (e.g. indicating an order of a product through a “tap” on the product's image in an e-document. Such activation of an order may cause updates to be made relating to the product, such as updating inventory levels for the product; adding an order for the product to an order list in a shopping cart; etc.). Typically an e-document is provided as an interactive pdf file, so a user can “click” /“tap” on an image of a product, causing a related action to be initiated by platform 102.

Referring to FIG. 6, algorithm 600 illustrates general sets of processes/actions

executed by video call processing sub-process 206f in organizing, executing, and updating data for video calls operated with or through platform 102. While telephone calls, Facetime calls, and other internet-based video call applications (e.g. Zoom, Microsoft Teams, GoTo Meetings, and others) can be provided, one embodiment provides a built-in video-call facility that uses the contact information and the local cameras and microphones on the local devices enabling the two communicating persons (e.g. the sales representative and the retailer) to establish person-to-person dialog quickly and conveniently. Sub-process 206f has start process 602, then upon a certain trigger (e.g. call time as set in data or a call initiated by a user), at process 604 a video call is initiated. Sub-process 206f is also configured to operate as a processing thread, so that other processes may execute simultaneously with a video call. As such, during a video call, platform 102 can still simultaneously/concurrently execute other processes 206a-e (e.g. order processing, e-document updates, etc.).

At a certain instance (e.g. before, after, or during the call), any additional information, data, orders, trigger conditions, etc., entered into platform 102 from the call are entered into or extracted from platform 102. Such additional information may be provided into the system by a user activating an appropriate update command during the call.

With video call implemented through process 206f, a retailer (e.g. a convenience store owner) may discuss and show a vendor (e.g. a candy bar vendor) product layouts and displays for the vendor's products at the retailer's site. The vendor may be able to see issues and areas for improvements through the video call that would not be evidence through email or telephone communications with the retailer. Further, as discussed below, links and integration with other processes 206 in platform 102 enable related product orders, deliveries, etc. from the vendor to be updated in view of information obtained from the call. The other processes may be automatically initiated after the call or may be running in parallel with the call, providing a streamlined and integrated system for extracting, processing, and integrating data, insights, and information garnered from a video call to other data/order/retailer information and data processed by platform 102.

Alternative or complementary communication media in process 206f may be via text messaging, a voice call, a text chat session, emails, or other electronic communication methods. Information provided through such alternative media sessions may also be automatically extracted and populated into other processes (e.g. order processing, flyer updating, etc.).

Referring to FIG. 7, algorithm 700 illustrates general sets of processes/actions executed by trigger processing sub-process 206g in reviewing and analyzing data in platform 102 a trigger event which may require an additional action. The data may be the status of an order, the status of inventory, etc. The trigger event may be an inventory level, a payment date, a publication deadline, an order submission deadline, etc. The resulting action may be a reorder notice or a reminder trigger, etc. Sub-process 206g has start process 702, then upon a certain trigger (e.g. a daily check), at process 704, database 104 is checked for any trigger events and thresholds (e.g. cut-off thresholds for orders based on time/date) and from that review, related vendor search parameters (e.g. proximity of vendor to retailer) are identified. Next, at process 706, database 104 is checked for vendors matching search parameters and cut-off thresholds. Next, as one possible action, at process 708, one or more types of electronic messages (e.g. text messages, SMS messages, automated calls to voice mail, and/or email messages) may be generated and sent to vendor(s) that have matched any cut-off threshold. Finally at process 710, exception events may be processed. For example, if a vendor has special trigger instructions (e.g., city location), then process 700 may generate and send alternative message (e.g. an automated call). Initiation and execution of process 700 may be provided through cron controlled processes (e.g., with PHP scripts). In an embodiment, scripts operating on platform 102 will periodically check (via daily check by PHP scripts) for which users are triggered to be notified of an upcoming event associated with it.

For example, in one embodiment, a Common Gateway Interface (CGI) script provides a routine that is called periodically to identify upcoming notification reminders for users and for triggered events, cause an email to be sent. Below is a part of an exemplary GGI script. Below is an extract of an exemplary reminder script:

```
  #################################################
  # Remind Engine
  # This sends reminder emails but not notifications to customers to remind them to get their order
  # in on time - this script only depends on the field custom_field_autoreminder script
  # This will send out emails to people two days back from when this ran.
  #################################################
  # Set environment
    set_time_limit(0);
  ini_set(‘max_execution_time’, 0);
  error_reporting(E_ALL & ~E_STRICT & ~E_DEPRECATED & ~E_NOTICE & ~E_WARNING);
  # Where is the script base
  $sSiteRoot = ‘/home/hydes/public_html/admin.tonol.ca’;
  $sDocRoot=/home/hydes/public_html/admin.tonol.ca/includes_accounts/reminder_notify;
  # Misc. Includes
  require_once($sDocRoot . “/config.inc”);
  require_once($sSiteRoot . “/includes/php_mailer.new/src/PHPMailer.php”);
  require_once($sSiteRoot . “/includes/php_mailer.new/src/SMTP.php”);
  require_once($sSiteRoot . “/includes/php_mailer.new/src/Exception.php”);
  require_once($sDocRoot . “/includes/engine_functions.inc”);
  # Start header
  echo “\n”;
  echo “#######################################################\n”;
  echo “Starting Remind (phone notification) Script on “ . $sDateFull . “ (PHP “. phpversion( ) . ”)\n”;
  # Check if already running
  funcCheckIfRunning( );
  # Get cities based on day
  if ($sDay == “Mon”):
    # These Monday emails
    $sCities = “custom_field_autoreminder like ‘%City1%’ or custom_field_autoreminder like
    ‘%City2%’;
  elseif ($sDay == “Tue”):
  # These Tue emails
      $sCities = “custom_field_autoreminder like ‘%City2%’ or custom_field_autoreminder like
      ‘%City3%’
  endif;
while ($sqlCustomersRow = $sqlGetCustomersResult −> fetch( ))
    if ($sqlCustomersRow[‘notification_token’] == “”)
    echo “ - Missing token for account “ . $sqlCustomersRow[‘email_address'] . “, skipping...\n”;
    continue;
  else
    sleep(2);
    echo “ - Sending notification to “ . $sqlCustomersRow[′email_address′] . “: ”;
  $notification= [‘title’ => ‘Reminder!’, ‘body’ => ‘Please have your order in before 11:00 AM to ensure
  on time delivery’];
  $data = [“notification_foreground” => “true”,
    “isVideoCall” => false,
    “priority” => “high”,
    “content_available” => true ];
    $fcmNotification = [‘to’ => $sqlCustomersRow[‘notification_token’],
      ‘notification’ => $notification, ‘data’ => $data ];
    $cRequest = curl_init( );
    echo $aResult[‘success'] . “\n”;
```

It will also be appreciated that alternatives implementations of any process or algorithm described herein may be provided implementing loops and actions in different orders and arrangements (e.g. in parallel with other processes), while still implementing actions and features as described.

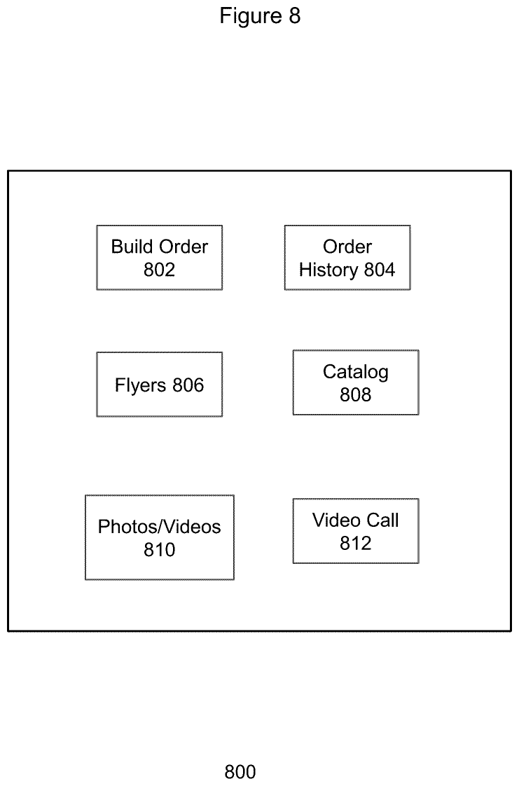

Now, further details are provided on an exemplary vendor interface for platform 102. Referring to FIG. 8, vendor has its client device 112. Graphical user interface 800 shows a block diagram of processes that are diagrammatically shown on the display of device 112. At device 112, vendor may activate any of GUI buttons shown therein to activate a related process executed on platform 102. Buttons include: “build order” button 802, which initiates a data form allowing the vendor to enter details for a new product order; “order history” button 804, which initiates a form allowing the vendor to review the status of executed orders; “flyer” button 806, which initiates a form allowing the vendor to review posted flyers; “catalog” button 808, which initiates a form allowing the vendor to review posted catalogs; “photo” button 810, which initiates a form allowing the vendor to review posted photographs, which may include photographs of planograms, layouts, store conditions, etc.; and “video call” button 812, which initiates a request to establish a video call with the retailer.

It will be seen that an embodiment for platform 102 provides several features for managing retailer/vendor relationships. For one implementation, a “small market/size” retailer (e.g. a convenience store or gas station), may have multiple small orders with a particular vendor (e.g. a candy bar vendor). Plan-o-grams and product layouts at the retailer may be reviewed via a video call through platform 102 and then product orders, placements, etc. may be adjusted accordingly seamlessly. As well, for the vendor, as it may have several small market/size retailers in a disperse area, the online and video features enable the vendor's sales representative to make positive and visual contact with several retailers in an area without having to physically travel to each and every retailer.

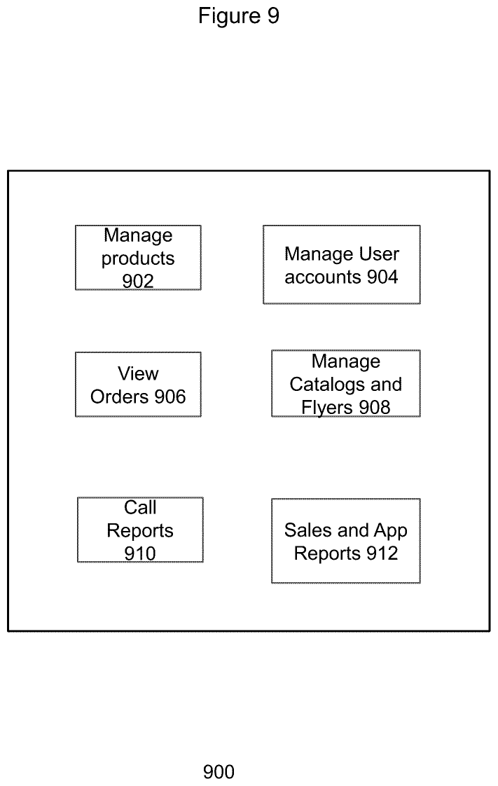

Now, further details are provided on how a retailer manages data and vendors through platform 102. Referring to FIGS. 9, 10b, and 10c, retailer accesses platform 104 (e.g. through a terminal or device 112). Graphical user interface 900 shows a block diagram of processes that are diagrammatically shown on the display of device 112. At device 112, retailer may activate any of GUI buttons shown therein to activate a related process executed on platform 102. Buttons include: “manage products” button 902, which initiates data forms allowing retailer to add/modify/delete products tracked by platform 102; “manage user accounts” button 904, which initiates interfaces allowing retailer to add/modify/delete vendors in platform 102; “view orders” button 906, which initiates a form allowing retailer to review the status of orders; “manage catalog/flyer” button 908, which initiates a form allowing retailer to review and manages posted vendor catalogs and retailer flyers; “call reports” button 910, which initiates a form provides details of calls tracked by platform 102; and “sales and app reports” button 912, which initiates a form allowing retailer to select and generate various reports (e.g. product sales, vendor sales, inventory levels, app usage), from data processed by platform 102. For each action a separate tab or window providing a GUI and actions may be initiated, thereby enabling multiple parallel windows and actions to be open and accessible simultaneously (e.g. a video call with an order processing action). Integration of features from one process to another (e.g. video call to order processing), provides a one-stop interface for a retailer and vendor to manage their relationship and orders.

FIG. 10b shows exemplary screen image 1000b of a set of commands available under to a retailer under platform 102, showing in part various sales reports (product, timeline, by flyers, by catalogs, etc.) that can be generated. FIG. 10c shows exemplary screen image 1000c of a set of commands available under to a retailer under platform 102, showing in part various product management actions (view product, current inventory, orders, etc.) that can be initiated.

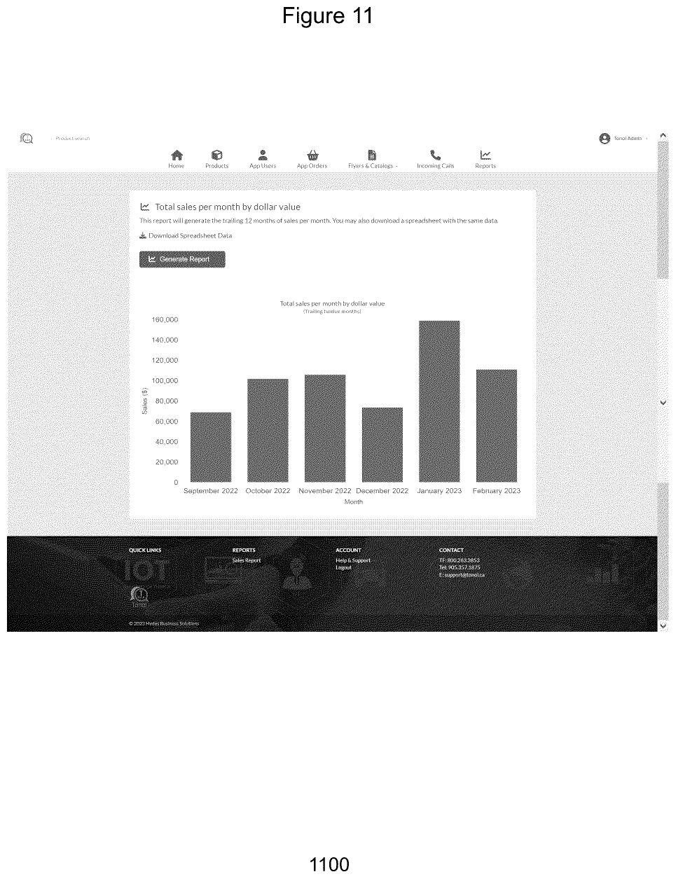

Corresponding to FIG. 9 and related GUIs, an embodiment provides a comparable vendor-centric set of tools and GUIs to manage retailers, orders, and catalogs on platform 102 and a set of platform administrator tools and GUIs to manage data, retailers, vendors, reminders, triggers, and related accounts on platform 102. FIG. 10d shows exemplary screen image 1000d of a set of commands available under to an administrator of platform 102, showing in part various account management actions (view and modify customers, locations, devices, etc.) that can be initiated. FIG. 11 shows exemplary screen image 1100 of a sales report of a product generated by platform 102, showing in part sales by month statistics based on data in platform 102. As well, platform 102 can generate reports on orders, initiate commands to manage products, users, flyers, and catalogs, and view the images/photos that might have been sent.

It will be seen that reports and data entered and accessed in GUIs 800 and 900 are based on interactions with database 104. Returning to database 104, further details are now provided on its contents. The tables below show representative records which may be stored, tracked, analyzed, and updated in database 104 relating to information on orders, vendors, advertisement, contact details and others. Metadata may also be provided and analysed to generate parts of such reports. For example, metadata may identify geographically interesting information (e.g. the province/state/city that has the most and least orders, the sales representatives with the most and least orders, etc. It will be appreciated that database search and update commands can identify cross-relationship(s) amongst records, triggering additional actions over direct events (e.g. “update database record”) as noted herein.

TABLE A
Retailer details

| Field | Data | Notes |
|---|---|---|
| Retailer | Walmart | |
| Retailer ID | 2000 | |
| Locations | Toronto East | |
| Location ID | A | |
| Location Rep | Jane Brown | |
| Account billing cycle | 1^{st} day of every month | |
| Trigger event/action | 1^{st} day of every month | Advance notice to vendors |
| Trigger event/action | Low inventory | Reorder reminder |
| Retailer representatives: | Jane Brown | |
| Vendor: | Apple Inc. | |
| Vendor ID: | 2000 or nickname (e.g. | |
| | ZIPPO) | |
| Vendor Reps: | Jim Smith/Ontario | |
| Vendor: | Apple Inc. | |
| Price Level: | | Price level triggers |
| Email Contact: | jimsmith@apple.com | |
| SMS contact: | 999-999-9999 | |
| Account Password: | Jsmithpwd | |
| Account type | Main, root, admin, or rep | |
| Security level | 1 through 5 | Different security levels |
| | | provide different access and |
| | | capabilities to define account |
| | | limitations |

TABLE B
Vendor details

| Field | Data | Notes |
|---|---|---|
| Vendor | Apple Inc. | |
| Vendor account number | 2000 | |
| Account billing cycle | | |
| Account creation date | | |
| Vendor contact: | Jim Smith | |
| Trigger event/action | | |
| Retailer: | Walmart | |
| Retailer contact: | Jane Brown | |
| Vendor custom fields | | Misc. data, settings, contact |
| | | preferences, etc. such as, |
| | | app theme colors, video call |
| | | settings, which email address |
| | | gets new order notifications, |
| | | etc. |

TABLE C
Retailer Order details

| | | |
|---|---|---|
| Field | Data | Notes |

| | |
|---|---|
| Order No. | 1 |
| Date: | Jan. 1, 2023 |
| Vendor | Walmart |
| Vendor account number | 2000 |
| SKU of items orders | 1000 |
| Description of item order | Walmart Brand Jeans |
| Quantity of item order | 500 |
| Price of item order | $10.50 |
| Delivery | Jan. 31, 2023 |
| Reorder level | 500 |
| Advertisement data | In weekly flyer for two weeks |
| Product | Chocolate bar |
| Order note | |
| Order total value | |
| Retailer who placed order | |
| (Retailer ID) | |
| Misc. | |

An embodiment provides a “tagging” feature enabling multiple data fields and information to be associated with a product. A ‘tag’ data type is a custom text label for a product that the user may dynamically associate with that product and others. As such, when a product is associated with a specific ‘tag’ label, the ‘tag’ data type is updated for that product and other ‘tagged’ products having the same label. As such, a search can be conducted for all products having the same tag. For example, the tag “Jeans” can be associated with multiple brands of pants and jeans. When a search is conducted using the tag “jeans”, then all associated “jean”-tagged products would be located. Tags enables platform 102 to categories items into groups of dynamically-tagged items as needed, which is useful when building orders. Table D below shows exemplary fields for products tracked in platform 102 with their ‘tag’ field.

TABLE D
Product tags

| Field | Data | Notes |
|---|---|---|
| Product code/SKU | 19169348402 | |
| Assigned user | Vendor A | Identifies which user that this |
| | | is for (e.g. for Zippo Inc.), |
| | | since platform 102 supports |
| | | multiple users, retailers, and |
| | | vendors |
| Tag | “Drinks” | Added by user |
| Price | Price levels, e.g. Price levels | This data may also be listed |
| | a-g | in the Products table. |
| Stock | Stock on hand | This data may also be listed |
| | | in the Products table. |
| Image | URL to image of product | This data may also be listed |
| | | in the Products table. |

TABLE E
Advertisement details

| Field | Data | Notes |
|---|---|---|
| Vendor | Walmart | |
| SKU | 1000 | |
| Description | Walmart Brand Jeans | |
| Text | “two for one” | |
| Retail price | $19.99 | |
| Start Date | Mar. 31, 2023 | |
| End Date | Mar. 31, 2023 | |
| Images | To show in app | Image data for |
| | | advertisement |

TABLE F
E-Documents

| Field | Data | Notes |
|---|---|---|
| Vendor | Walmart | Owner of flyer |
| Type | Catalog/Flyer | Catalog, flyer, or other |
| Frequency | Weekly/Monthly | Data updated |
| E-document file | | Storage location in database |

For e-documents, it will be appreciated that one or more database tables shown as Table F may be provided separately for flyers and catalogs. These tables may have fields and data relating to various aspects of the e-document (e.g. vendor, frequency of publication, e-document title, last updated date, size of document, actual PDF of e-document, etc.).

TABLE G
Other details/data

| Field | Data | Notes |
|---|---|---|
| Type | Catalog | |
| Related Item | Image files, pdfs | Data for products for catalog |

The above embodiment is shown as a retailer-centric implementation. It will be appreciated that other embodiments may provide vendor-centric or customer-retailer centric platforms, with suitable modifications made to the data, the data fields, the trigger conditions, the GUIs, etc. A specific retailer may access platform 102 and manage its users and products, review orders and reports, etc. using the processes and functions described herein. As well, in other embodiments, multiple retailers' operations with their multiple locations and their multiple vendors may be collectively managed on platform 102. In such an embodiment, each retailer may have its unique access, functions and data in platform 102, but collectively, platform 102 simultaneously manages multiple vendors' activities. As such, an embodiment provides on one physical platform 102, multiple independent separate environments for multiple retailers, where each retailer can set up different data, e-documents, triggers, etc. for its vendors to place orders for a set of products that are only for that retailer with data, settings, users, etc. being retailer/vendor specific. In such a platform, economies of scale are provided. The embodiment also provides a central (single) platform administrator for all clients.

It will be appreciated that various tasks, commands, and processes provided by an embodiment may be managed exclusively by either client 112, process 206, and/or platform 102 or through allocating specific tasks among the entities, with appropriate messaging and signalling being provided. For example, an embodiment may implement a logical allocation of such tasks between client 112 and process 206a, depending on various factors, such as location of relevant data, communications needed between the devices, relative processing capacities of the devices, and others. For one implementation, client 112 provides processes to receive and analyze data generated and sent on device 108 and requests relevant metadata from obtained from platform 102.

The various features described above may be implemented in, and fully automated by processes executed by general-purpose electronic devices, including but not limited to data center servers, PCs, tablets, laptops, and mobile phones. The processes may be stored in any type or types of computer storage device or memory. It should be understood that the various steps may alternatively be implemented in-whole or in-part within specially designed hardware.

It will be appreciated that all processes, algorithms, devices, modules, servers, databases, database querying systems, and elements described herein for embodiments and related processes, steps or functions may be implemented using known programming techniques, languages, scripts (such as Common Gateway Interface scripts), and algorithms, such as PHP, Java, C++, Python, SQL, and others. Such processes may be executed in whole or in part on one or more of platform 102 and/or clients 112. Apps on clients 112 may provide selected GUI, input/output, data processing, and data collection features and interfaces described herein to platform 102. Although the processes, services and modules described herein are implemented in software operating on an electronic device having the display, it will be appreciated that some or all functions of these processes may be provided in a separate device(s) or server(s) that communicate with the electronic device. The titles of processes and platforms are provided as a convenience to provide labels and assign functions to certain processes. It is not required that a process perform only its functions as described above. As such, specific functionalities for each application or process may be moved between processes or separated into different processes. Processes may be contained within other processes. Different signaling techniques may be used to communicate information between applications using known programming techniques. Known data storage, access and update algorithms allow data to be shared between applications. It will further be appreciated that other applications and systems on devices and servers may be executing concurrently with other processes. Known mathematical algorithms, such as order processing algorithms, database update algorithms, and others, may be implemented using programming techniques known in the art. As such, any of modules (or parts thereof) may be structured to operate in as a “background” application on devices and servers, respectively, using programming techniques known in the art.

It will be appreciated that the embodiments relating to clients, servers, services, state machines and systems may be implemented in a combination of electronic hardware, firmware, and software. The firmware and software may be implemented as a series of processes, applications and/or modules that provide the functionalities described herein. The algorithms and processes described herein may be executed in different order(s). Interrupt routines may be used. Data may be stored in volatile and non-volatile devices described herein and may be updated by the hardware, firmware and/or software.

As used herein, the wording “and/or” is intended to represent an inclusive-or. That is, “X and/or Y” is intended to mean X or Y or both.

In this disclosure, where a threshold or measured value is provided as an approximate value (for example, when the threshold is qualified with the word “about”), a range of values will be understood to be valid for that value. For example, for a threshold stated as an approximate value, a range of about 25% larger and 25% smaller than the stated value may be used. Thresholds, values, measurements and dimensions of features are illustrative of embodiments and are not limiting unless noted. Further, as an example, a “sufficient” match with a given threshold may be a value that is within the provided threshold, having regard to the approximate value applicable to the threshold and the understood range of values (over and under) that may be applied for that threshold.

Although this disclosure has been described in terms of certain embodiments and applications, other embodiments and applications that are apparent to those of ordinary skill in the art, including embodiments which do not provide all of the features and advantages set forth herein, are also within the scope of this disclosure. Accordingly, the scope of the present disclosure is intended to be defined only by reference to the following claims.

1. An electronic platform for processing orders related data for a retailer supporting a plurality of vendors, comprising:
a processor executing instructions that:
manage a database containing vendor data, retailer data, and order data; and
provide a video call between the retailer on a first electronic device and a selected vendor of the plurality of vendors on a second electronic device;
the processor further executing instructions that:
in a first process, manage the vendor data and the order data in the database through commands provided through a first graphical user interface (GUI);
in a second process, manage the video call in a second GUI; and
in the first process, update the vendor data and the order data in the database through information provided through the video call in the second GUI,
wherein
the first electronic device is in communication with the platform to provide retailer data and order data to the database;
the second electronic device is in communication with the platform to provide vendor data to the database; and
the first and second processes generate the first and second GUIs on the first device.

2. The electronic platform for processing orders as claimed in claim 1, wherein:
the database contains multiple vendors' data; and
each vendor is provided a separate operating platform from the other vendors.

3. The electronic platform for processing orders as claimed in claim 2, wherein:
the first process executes in parallel with the second process; and
the first and second GUIs are in view simultaneously on the first electronic device.

4. The electronic platform for processing orders as claimed in claim 1, wherein the database further comprises flyer data, catalog data, and trigger events.

5. The electronic platform for processing orders as claimed in claim 3, wherein the processor further executes instructions that:
review contents of database for a match between a trigger event and a matching vendor of the plurality of vendors in the vendor data;
provide an electronic communication to a third electronic device associated with the matching vendor upon the match;
update the database upon the match; and
store orders and then forwards orders to the third electronic device.

6. The electronic platform for processing orders as claimed in claim 3, wherein the processor further executing instructions that:
in the first process, manage the flyer data in the first GUI; and
in the third process, update the flyer data in the database.

7. The electronic platform for processing orders as claimed in claim 6, wherein the processor further executing instructions that:
in the second process, manage the catalog data in the second GUI; and
in the third process, update the catalog data in the database.

8. The electronic platform for processing orders as claimed in claim 6, wherein:
the flyer data is captured in an interactive pdf document.

9. The electronic platform for processing orders as claimed in claim 3, wherein the processor further executing instructions that in the first process:
through the first GUI, enable tagging of products with a tag identifier; and
enable searching products having the same tag identifier.

10. The electronic platform for processing orders as claimed in claim 9, wherein the processor further executing instructions that in the first process:
through the first GUI, enable searching of products having the tag identifier; and
update the order data relating to the products having the same tag identifier.

11. A method for processing orders related data for a retailer supporting a plurality of vendors on an electronic platform for, the method comprising:
executing instructions on a processor in the platform that:
manage a database containing vendor data, retailer data, and order data; and
provide a video call between the retailer and a selected vendor of the plurality of vendors;
further executing instructions on the processor that:
in a first process, manage the vendor data and the order data in the database through commands provided through a first graphical user interface (GUI);
in a second process, manage the video call in a second GUI; and
in the first process, update the vendor data and the order data in the database through information provided through the video call in the second GUI,
wherein
a first electronic device associated with the retailer is in communication with the platform to provide retailer data and order data to the database;
a second electronic device associated with the selected vendor is in communication with the platform to provide vendor data to the database; and
the first and second processes generate the first and second GUIs on the first device.

12. The method for processing orders as claimed in claim 11, wherein:
the database contains multiple vendors' data; and
each vendor is provided a separate operating platform from the other vendors.

13. The method for processing orders as claimed in claim 12, wherein:
the first process executes in parallel with the second process; and
the first and second GUIs are in view simultaneously on the first device.

14. The method for processing orders as claimed in claim 11, wherein the database further comprises flyer data, catalog data, and trigger events.

15. The method for processing orders as claimed in claim 13, wherein the method further executes instructions on the processor that:
review contents of database for a match between a trigger event and a matching vendor of the plurality of vendors in the vendor data;
provide an electronic communication to a third electronic device associated with the matching vendor upon the match;
update the database upon the match; and
store orders and then forwards orders to the third electronic device.

16. The method for processing orders as claimed in claim 13, wherein the method further executes instructions on the processor that:
in the first process, manage the flyer data in the first GUI; and
in the third process update the flyer data in the database.

17. The method for processing orders as claimed in claim 16, wherein the method further executes instructions on the processor that:
in the second process, manage the catalog data in the second GUI; and
in the third process update the catalog data in the database.

18. The method for processing orders as claimed in claim 13, wherein the method further executes instructions on the processor that:
in the first process through the first GUI, enable tagging of products with a tag identifier; and
in the first process enable searching products having the same tag identifier.
